(19) United States
(12) Patent Application Publication
(10) Pub. No.: US 2022/0138965 A1
(43) Pub. Date: May 5, 2022

(54) FOCUS TRACKING SYSTEM

(71) Applicant: REY FOCUSING LTD., Herzliya Pituach (IL)

(72) Inventors: Isaac CANETTI, Haifa (IL); Gili Simcha POGOZELITS, Caesarea (IL)

(73) Assignee: REY FOCUSING LTD., Herzliya Pituach (IL)

(21) Appl. No.: 17/428,834

(22) PCT Filed: Feb. 5, 2020
(86) PCT No.: PCT/IB2020/050927

§ 371 Date: Aug. 5, 2021

Related U.S. Application Data
(60) Provisional application No. 62/801,107, filed on Feb. 5, 2019.

(51) Int. Cl. G06T 7/246; G06T 7/40; G06V 10/25; G03B 13/36; H04N 5/232

(52) U.S. Cl. CPC G06T 7/246; G06T 7/40; G06T 2207/30236; G03B 13/36; H04N 5/23212; G06V 10/25

(57) ABSTRACT

A method of automatically tracking a moving target, the method including viewing on an imager a region of interest (ROI) on the target, acquiring a first image of the ROI and mapping a set of points associated with the first ROI image on an X-Y coordinate system associated with a focal plane in a field of view (FOV) of the imager, acquiring a second image of the ROI and mapping a set of points associated with the second ROI image on the X-Y coordinate system, and comparing a location of the first set of ROI image points on the X-Y coordinate system with the second set of ROI image points. The method additionally includes computing a first angular distance between the first set of ROI points and the second set of ROI points, and determining whether the ROI has moved to a different focal plane.

### CROSS-REFERENCE TO RELATED APPLICATIONS

This application claims benefit from U.S. Provisional Patent Application No. 62/801,107 filed 5 Feb. 2019 which is hereby incorporated in its entirety by reference.

### FIELD OF THE INVENTION

The present invention relates to optical imaging systems generally and, more particularly, but not exclusively, to a system and method of focus tracking, and target locking and tracking.

### BACKGROUND OF THE INVENTION

An autofocus (or AF) system generally includes at least one optical sensor, a control system and a motor to focus a camera onto an automatically or manually selected point or area, hereinafter referred to as region of interest (ROI). The sensors generally serve to determine the correct distance of the ROI to the imaging system. Some AF systems use a single sensor, while others use an array of sensors. Most modern SLR cameras use through-the-lens optical sensors. The AF system may additionally include an electronic rangefinder which may be used to determine the distance to the ROI, with the ROI and optionally the distance generally displayed on a screen on the camera or otherwise on the system. Autofocusing is generally done using one of two mechanisms; either a motor in the camera body and gears in the lens (“screw drive”) or through electronic transmission of the drive instruction through contacts in the mount plate to a motor in the lens. Lens-based motors may be of a number of different types, but are often ultrasonic motors or stepper motors.

Some AF systems may be able to detect whether the subject is moving towards or away from the camera, including speed and acceleration data, and may keep focus on the subject. Also commonly referred to as focus tracking, it is used to track a subject and/or an object as it moves around the frame, or towards and away from the camera. In stills photography the photographer constantly marks the ROI and the lens automatically focuses on the subject and/or object, making its use very popular for sports and action photography. In video photography, the auto focus system may track a subject and/or object by employing a shape detection algorithm and focuses the lens accordingly. In some AF systems, the control systems may make use of algorithms which constantly predict where a subject or an object is about to be based on its speed and acceleration data from the autofocus sensor.

### SUMMARY OF THE PRESENT INVENTION

There is provided, in accordance with an embodiment of the present invention, a method of automatically tracking a moving target, the method including viewing on an imager a region of interest (ROI) on the target, acquiring a first image of the ROI and mapping a set of points associated with the first ROI image on an X-Y coordinate system associated with a focal plane in a field of view (FOV) of the imager, acquiring a second image of the ROI and mapping a set of points associated with the second ROI image on the X-Y coordinate system, and comparing a location of the first set of ROI image points on the X-Y coordinate system with the second set of ROI image points. The method additionally includes computing a first angular distance between the first set of ROI points and the second set of ROI points, and determining whether the ROI has moved to a different focal plane.

In some embodiments, the method may include using texture analysis to map the first set of ROI points and the second set of ROI points. The method may additionally include using texture analysis to compute the first angular distance.

In some embodiments, the method may include using the first angular distance to compute a first angle of deviation between the ROI and a line extending perpendicularly from the imager to the focal plane. Optionally, the method may include measuring a distance to the ROI along a vector extending from the imager at the first angle of deviation.

In some embodiments, the method may include acquiring a third image of the ROI and mapping a set of points associated with the third ROI image on the X-Y coordinate system. It may additionally include comparing a location of the third set of ROI image points on the X-Y coordinate system with the second set of ROI image points. It may additionally include computing a second angular distance between the third set of ROI points and the second set of ROI points. It may further include using the second angular distance to compute a second angle of deviation between the ROI and the line extending perpendicularly from the imager to the focal plane. It may additionally include measuring a distance to the ROI along a vector extending from the imager at the second angle of deviation.

In some embodiments, the method may include acquiring the first ROI image and the second ROI image using a frame speed greater than 25 frames per second.

In some embodiments, the method may include acquiring the first ROI image and the second ROI image using a frame speed of 100 frames per second.

In some embodiments, the method may include automatically adjusting a focus based on the determining whether the ROI has moved to a different focal plane.

There is provided, in accordance with an embodiment of the present invention, a system for automatically tracking a moving target including an imager for viewing a region of interest (ROI) on the target, a sensor for acquiring a first image of the ROI and for acquiring a second image of the ROI, and a control system for mapping a set of points associated with the first ROI image on an X-Y coordinate system associated with a focal plane in a field of view (FOV) of the imager and for mapping a set of points associated with the second ROI image on the X-Y coordinate system. The control system may additionally compare a location of the first set of ROI image points on the X-Y coordinate system with the second set of ROI image points, may compute a first angular distance between the first set of ROI points and the second set of ROI points, and may determine whether the ROI has moved to a different focal plane.

In some embodiments, the control system may use texture analysis to map the first set of ROI points and the second set of ROI points. Optionally, the control system may use texture analysis to compute the first angular distance.

In some embodiments, the control system may use the first angular distance to compute a first angle of deviation between the ROI and a line extending perpendicularly from the imager to the focal plane.

In some embodiments, the focus tracking system may include a rangefinder to measure a distance to the ROI along a vector extending from the imager at the first angle of deviation.

In some embodiments, the sensor may acquire a third image of the ROI and may map a set of points associated with the third ROI image on the X-Y coordinate system. Optionally, the control system may compare a location of the third set of ROI image points on the X-Y coordinate system with the second set of ROI image points. Additionally, the control system may compute a second angular distance between the third set of ROI points and the second set of ROI points. Optionally, the control system may use the second angular distance to compute a second angle of deviation between the ROI and the line extending perpendicularly from the imager to the focal plane.

In some embodiments, the rangefinder may measure a distance to the ROI along a vector extending from the imager at the second angle of deviation.

In some embodiments, the imager may acquire the first ROI image and the second ROI image using a frame speed greater than 25 frames per second. Optionally, the imager may acquire the first ROI image and the second ROI image using a frame speed of 100 frames per second.

In some embodiments, the focus tracking system may include an automatic focus system to automatically adjust a focus of the imager when the ROI has moved to a different focal plane.

In some embodiments, the first set of points and the second set of points each include at least one or more coordinates on the X-Y coordinate system.

In some embodiments, the focal plane is associated with a focal distance from the imager.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 schematically illustrates operation of Focus Tracking System, according to an exemplary embodiment of the present invention;

FIG. 2 schematically illustrates the operation of the Focus Tracking System as imaged on an imager sensor and associated with a focal plane in a field of view of the imager, according to an exemplary embodiment of the present invention;

FIG. 3 schematically illustrates the Focus Tracking System including its components, according to an exemplary embodiment of the present invention;

FIG. 4 schematically illustrates the Focus Tracking System installed in a vehicle, according to an exemplary embodiment of the present invention;

FIGS. 5A to 5F schematically illustrate an operational scenario of the use of the Focus Tracking System installed on the vehicle in FIG. 4, according to an exemplary embodiment of the present invention; and

FIG. 6 is a flow chart of a method of using the Focus Tracking System, according to an exemplary embodiment of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Focusing a moving subject and/or object (hereinafter referred to as “target”) is a major issue in AF systems. With today's technology, the photographer generally chooses a dynamic autofocusing mode whenever a picture of a moving target is to be taken. This dynamic autofocusing mode may include use of contrast detection and/or phase detection. Drawbacks associated with these autofocusing modes include their being relatively slow, in stills photography they require the operator to manually and constantly mark the ROI, and in video they generally rely on a shape detection algorithm to detect movement of the ROI which may be costly to implement. Additionally, they are generally unable to accurately focus onto rapidly moving targets, and often need restricting conditions such as lighting and layout of the target.

In an attempt to solve the aforementioned problem, as previously mentioned in the Background, the AF systems may use algorithms to predict the position to which the target is going to move and will focus onto the predicted position. A well-known camera manufacturer, Canon has labelled this type of technique as “AI Servo”, the AI being an acronym for artificial intelligence, while a second also well-known manufacturer, Nikon, has labeled this type of technique “Continuous/AF-C”. A problem with these techniques is that relatively large amounts of power are required as the lens is continuously hunting for focus on predicted movement, even if the target is suddenly stationary, and in many cases not successfully.

Applicant has realized that the abovementioned problems using the existing technologies may be solved by implementing the system and method of the present invention disclosed herein. The system and method may include viewing a region of interest (ROI) on an image of the target and identifying the ROI on an XY coordinate system associated with the field of view (FOV) of the particular camera lens in use. A set of one or more subsequent images of the target (taken immediately after the first) may then be acquired and each is compared with the previous image to check the movement in the XY coordinate system of the ROI in the subsequent images relative to the first image. The new coordinates for the ROI in the one or more subsequent images may then be provided to a control system that instructs a tracking system to position a rangefinder to point at the new coordinates of the ROI in the images (if only two images are used in a set, at the coordinates of the ROI in the second image) and to mark the target at the ROI. The distance to the new coordinates of the ROI may then be measured by the rangefinder and may be transferred to the camera which utilizes the distance data to automatically adjust the focus at the target. The rangefinder may include a laser rangefinder or other suitable rangefinder known in the art and a method of measuring and calculating the distance. Optionally, the camera may be motion driven and the tracking system may drive motors or other motion mechanism connected to the camera to move the camera while maintaining the ROI stationary in the viewfinder.

In some embodiments, the set of one or more subsequent images, hereinafter referred to as “subsequent images”, may include “dead” frames which may be used to determine the coordinates of the ROI and perform the measurements (making measurements and tracking updates between the photographed frames.) Video shooting is generally performed and displayed at a “normal” rate of 25 frames per second (FPS). The system and method of the present invention may include shooting at a faster rate, for example, 100 FPS, which may allow alternating frame sampling. At 100 FPS, for every four frames filmed, three frames may be used for focusing and focus locking (10 msec for each frame) and the fourth frame may be a “real” frame after focusing and focus locking which is used to make the video. It may be appreciated by the skilled person that the subsequent images may include more or less frames, and that the shooting speed may be lower, for example 60 FPS, or higher, for example 200 FPS and greater. The “real” frame may then be prolonged to 40 msec (the normal length of a video frame) to avoid “flickering” of the viewed scene while in the background a “transparent” focusing and tracking process is being performed.

In some embodiments, the method may include use of texture analysis to identify the ROI on the images and determine its location on the XY coordinate system. Additionally or alternatively, other known methods may be used and may include contrast detection and phase detection, among others. The camera may remain stationary or move while acquiring each set of images as the ROI moves along the frame and changes coordinates. Additionally or alternatively, the focus tracking system may move with the target, the ROI optionally remaining stationary inside the frame.

It may be appreciated that the focus tracking system and method of the present invention may have numerous applications, practically in any application which may require tracking a moving target (subject and/or object) or moving a camera. It may be used to track and automatically focus onto a moving target using stills photography. It may also be used in video and cinematography where relatively large amounts of time and money are wasted by using traditional manual or autofocus methods and repetitive shootings as a result of a scene not being sufficiently focused. Other applications may include security systems, military systems, vehicle tracking systems (e.g. cars and other road vehicles, planes, rockets, etc.), autonomous driving systems, robotic systems, and robotic surgical systems, among many others.

It may be further appreciated that a particular application may include using the focus tracking system on drones. Drones generally rely on GPS information to automatically track a subject and/or an object. The GPS information may then be processed on the CLOUD and/or through a remote operator who manually marks the target. By adapting the focus tracking system onto drones, GPS information is no longer required as the tracking and focusing may be autonomously performed on-board.

Exemplary System and Method of Focus Tracking

The exemplary system and method of the present invention include marking a target with a laser or other rangefinder technique and focusing on the target by using fast rate image sampling of the target, detecting a ROI on the target using a texture motion sensing, and performing motion analysis and coordinate based position adjustment of the texture motion to control positioning of a rangefinder to focus onto the target. The image sampling may include use of a video camera capable of shooting at a fast rate which may be defined according to the target speed (person, car, missile, etc.).

In some embodiments, the system may acquire at a fast rate the space around the ROI on the target and may compare frames to determine motion of the ROI. The ROI may be marked by a laser rangefinder or any rangefinder system that may measure distance to the target. Taking pictures at a fast rate makes it possible to divide the movement of the target into very short segments and may allow comparing adjacent frames in time for texture shift or shifting of other identified points around the ROI. The system may then use the new data coordinates of the ROI shifting to mark the ROI with the rangefinder.

In an exemplary operation, a ROI on the target may be marked with the rangefinder for focusing. The ROI may be imaged and displayed on the camera image sensor in a first picture as one or more coordinates on a XY plane representing a focal plane of the lens at a focal distance from the lens, the focal distance represented by a perpendicular line extending from the lens to the focal plane. The ROI may be associated with a vector from the rangefinder to the target representing the deviation angle of the marker relative to the focal distance. U.S. Pat. No. 8,570,430 commonly owned by the applicant and incorporated herein by reference in its entirety describes a “method of focusing a camera having an optic axis and optic center to image a scene, the method comprising illuminating an off axis region of interest in the scene with a relatively small fiducial spot of light; determining a range of for the fiducial spot relative to the camera; and focusing the camera responsive to a scalar product of a vector from the camera optic center to the fiducial spot with a unit vector coincident with the camera optic axis”.

The ROI may then be imaged again at a preselected frame rate and the image displayed on the sensor as a second picture. The system may compare the location of the ROI in the second picture in the XY plane with that in the first picture. If there is any change in the location of the ROI, the system may check the movement on the XY plane of the sensor and provide the new coordinates to the drive system of the rangefinder, optionally to the whole camera. After the system has been updated with the new coordinates, the rangefinder now marks the ROI in its new location and determines the distance to determine whether the target is in the same focal plane or has moved to a new focal plane. If there was no movement, the system's reading will not change.

In some embodiments, the XY plane of the sensor matches the view angle of the lens. That is, for each focal length of the lens, the angle of view shown in the sensor changes. If a limited matrix of pixels is defined around the ROI linearity may be assumed in the deviation angle and in the distance represented by neighboring pixels. Each pixel may represent an angular shift of the target depending on the target distance and the angle of view of the lens. For a given example, shifting of the ROI by 3 pixels upwards and two pixels to the left may represent having to move the marker 3 degrees up and 2 degrees to the left at a given focal distance, or equivalently 6 cm up and 4 cm to the left. It may be appreciated that nonlinearity may occur at the edges of the lens, the nonlinearity generally defined by the lens manufacturer. Optionally, nonlinearity may be taken into account when the target is positioned in the lens' areas affected by nonlinearity.

Focus Tracking System Operation

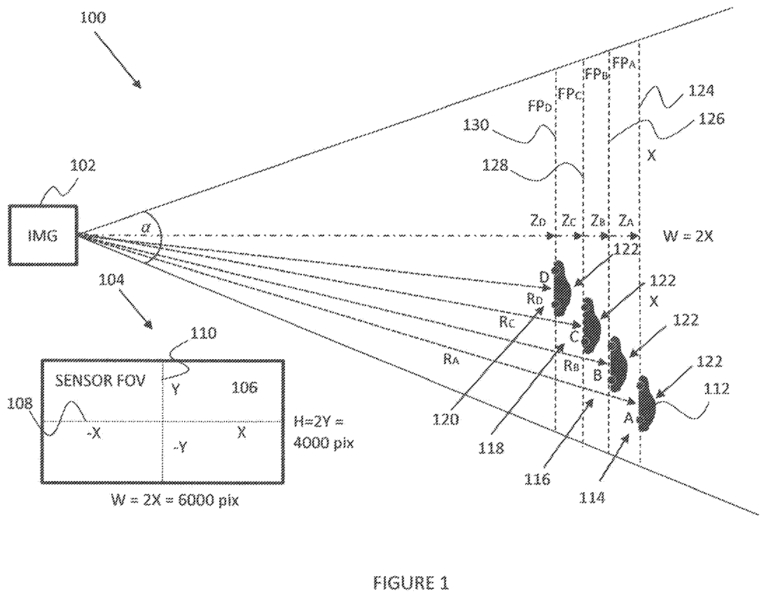

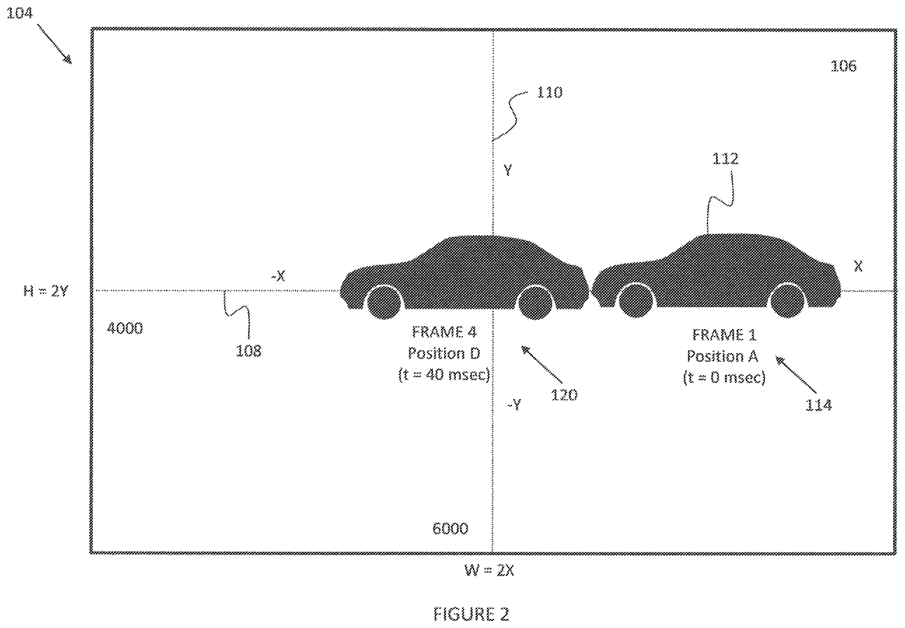

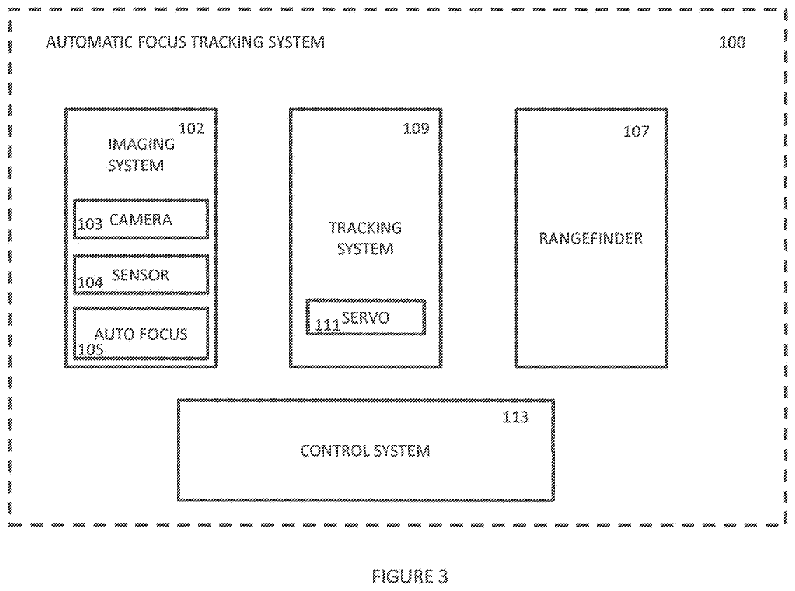

Reference is now made to FIGS. 1 and 2 which schematically illustrate an exemplary operation of a focus tracking system 100, according to an embodiment of the present invention. As may be seen in FIG. 1, focus tracking system 100, shown in greater detail in FIG. 3, may include an imaging system (IMG) 102 including a camera (camera 103 in FIG. 3) and a rangefinder (rangefinder 107 in FIG. 3). The angle of view of the camera lens may be defined by α. A sensor 104 in IMG 102 may be defined by an XY plane 106 with the width defined by W representing the X-axis 108 and the height H representing the Y-axis 110. The width of the field W covered by the lens at any focal distance Z from the camera may be expressed by 2X and the height H by 2Y, so that,

2X=2Z*tan(αx/2)

and

2Y=2Z*tan(αy/2).

For exemplary purposes, sensor 104 dimensions W×H may be 6000 pixels×4000 pixels, and therefore, each pixel in the focal plane covers horizontally 2X/6000 or X/3000, and vertically 2Y/4000 or Y/2000. Focus tracking system 100 is shown tracking a vehicle 112.

As previously described, the frame speed may be 100 FPS, allowing three frames to be used for tracking and focusing of the rangefinder as focus tracking system 100 tracks vehicle 112, and the fourth frame to be the captured image of the vehicle which is actually displayed as part of the video. In FIG. 1, vehicle 112 is shown in a position A at a time (t) 0<t<10 msec which coincides with a frame 1 114, in a position B at time (t) 10 msec<t<20 msec which coincides with a frame 2 116, in a position C at time (t) 20 msec<t<30 msec which coincides with a frame 3 118, and in a position D at time (t) 30 msec<t<40 msec which coincides with a frame 4 120. In FIG. 2 is vehicle 112 as imaged by sensor 104, with the vehicle in focus in position A in frame 1 114 at time t=0, and in focus in position D in frame 4 120 at time t=40 msec after focus tracking.

Referring back to FIG. 1, in frame 1 114, the lens of CAM 102 may be focused on a ROI 122 on vehicle 112 located in focal plane FPA 124 at a focal distance ZA from the camera lens. Vehicle 112 is in position A and ROI 122 may be marked by the rangefinder, as indicated by the vector RA. If at the focal distance ZA, X=10 m and Y=6 m then the distance between each pixel associated with focal plane FPA 116 along X-axis 108 represents 10 m/3000=0.00333 m (0.3 cm), and along Y-axis 110 the distance between each pixel represents 6 m/2000=0.00333 m (0.3 cm), not accounting for possible nonlinearity approaching the edges of the lens. If ROI 122 on vehicle 112, as pictured on frame 1 114, shifts 0.9 cm to the left and 0.0 cm upwards, it is currently 3 pixels to the left of its initial position (the vehicle has moved to position B). Analysis of ROI 122 new shifted position on sensor 104, which may include texture analysis among other techniques, provides new angular coordinates to focus tracking system 100 which moves the rangefinder to new position B, which may now be associated with a new vector RB.

In frame 2 116, the lens of the camera may be focused on ROI 122 in new position B (after the rangefinder has been moved to the new position) located in focal plane FPB 126 at a focal distance ZB from the lens. ROI 122 may be marked by the rangefinder, as indicated by vector RB to focus onto the ROI. As may be appreciated from the figure, vehicle 112 has moved forward and also closer to IMG 102. In order to detect ROI 122 in the new position prior to focusing, texture analysis may be used, among other techniques, to identify the unfocused ROI in position B prior to being marked by the rangefinder and focusing.

In frame 3 118, the lens of the camera may be focused on ROI 122 in new position C (after the rangefinder has been moved to the new position according to the new angular coordinates associated with another pixel shift on sensor 104) located in focal plane FPC 128 at a focal distance ZC from the lens, which may be associated with a new vector RC. ROI 122 may be marked by the rangefinder, as indicated by vector RC to focus onto the ROI. As may be appreciated from the figure, vehicle 112 has again moved forward and also closer IMG 102. In order to detect ROI 122 in the new position prior to focusing, texture analysis may be used, among other techniques, to identify the unfocused ROI in position C prior to being marked by the rangefinder and focusing.

In frame 4 120, the lens of the camera may be focused on ROI 122 in new position D ((after the rangefinder has been moved to the new position according to the new angular coordinates associated with another pixel shift on sensor 104) located in focal plane FPD 130 at a focal distance ZD from the lens, which may be associated with a new vector RD. ROI 122 may be marked by the rangefinder, as indicated by vector RD to focus onto the ROI. As may be appreciated from the figure, vehicle 112 has again moved forward and also closer to IMG 102. In order to detect ROI 122 in the new position prior to focusing, texture analysis may again be used, among other techniques, to identify the unfocused ROI in position D prior to being marked by the rangefinder and focusing.

As described above in the case of 100 FPS shooting rate, each frame may be about 10 msec in length, which may allow 30 msec to be used for aligning focus tracking system 100 and 10 msec may be used for the “real” image. In some embodiments, calibration of the camera lens may be done during the three frame sampling. The lens may receive from an auto focus system (auto focus 105 in FIG. 3) in IMG 102 a numerical value of the distance to which it should reach. Upon receiving feedback from the lens that it reached the required focus position, the shooting may continue as usual. If feedback is not received from the lens that it has reached a final focus state, then frame 4 120 will not be in focus. If the lens has not reached the position, it is possible to “steal” time (in 10 ms increments) in a control system (control system 113 in FIG. 3) to complete the lens adjustment process. In this case it may be possible to add another frame (10 msec), optionally more frames, to continue the process of adjusting the position of the lens until it reaches the final state.

In some embodiments, receiving feedback from the lens ensures that the “real” frames are in full focus. Having this information, focus tracking system 100 may erase the three sampling frames and may only store the “real” frames, thereby reducing the size of the video files.

Focus Tracking System Components

Reference is now made to FIG. 3 which schematically illustrates focus tracking system 100 including its components, according to an embodiment of the present invention. Focus tracking system 100 may include imaging system 102, a tracking system 109, rangefinder 107, and a control system 113.

Imaging system 102 may include a camera 103, sensor 104, and autofocus system 105. Camera 103 may include any suitable known stills camera or video camera with a shooting speed capability greater than 25 FPS which may allow one frame to be used for acquiring the focused image and the other one or more frames to be used for camera lens focusing. A shooting speed of camera 103 may be, for example, 50 FPS, 60 FPS, 100 FPS, 200 FPS, 250 FPS, 500 FPS, 750 FPS, 1000 FPS, or greater. Sensor 104 may include any suitable known image sensor, or array of sensors, and may include a pixel size of 24 MP or smaller, for example, 20 MP, 18 MP, 16 MP, or smaller, or may be greater than 24 MP, for example, 36 MP, 42 MP, 50 MP, or greater. Optionally, sensor 104 may be built into camera 103. Auto focus system 105 may include any automatic focusing mechanism which may adjust the camera's lens responsive to distance information received from rangefinder 107. Optionally, auto focus system 105 may be built into camera 103.

Tracking system 109 may track the target as it moves responsive to motion analysis performed by control system 113 based on the shifting information of the ROI as perceived from the pixel displacements on sensor 104. Tracking system 111 may include a servo mechanism 111 which may mechanically adjust an angular position of rangefinder 107 to maintain the rangefinder aligned with the target and to mark the target as it moves within the FOV of camera 103 (as imaged on sensor 104). Additionally or alternatively, servo mechanism 111 may mechanically adjust an angular position of camera 103 to maintain the target stationary in the FOV of camera 103 (as imaged on sensor 104). Rangefinder 107 may be any suitable known rangefinder and may include a laser rangefinder, an electroacoustic rangefinder, or other type of electronic rangefinder.

Control system 113 may control the operation of all system components and may process all imaging data acquired by imaging system 102, may process position information from tracking system 109, and may process distance information acquired from 107. Responsive to the processed information, control system 113 may provide control signaling to tracking system 109 to adjust the position of rangefinder 107 and/or camera 103 in order to track the position of the target. Control system 113 may provide control signaling to rangefinder 107 and responsive to measured distance information, may provide control signaling to auto focus system 105 for focusing camera 103. Control system 113 may additionally control shooting of images by imaging system 102 and may analyze acquired images, for example, by performing texture analysis, to determine movement of the target (the ROI) for target tracking purposes. Control system 113 may additionally select the frames which may be used system alignment purposes (tracking and/or focusing) and those which may be used for image reproduction, and may store in memory those used to construct the video images and may discard those used for alignment. Control system 113 may additionally process the frames, for example, by extending the length of a frame to prevent “flickering”, and may employ known compression techniques as required.

Autonomous Vehicles and Advanced Driver Assist

Applicant has realized that focus tracking system 100 may be advantageously used in autonomous vehicles (AV) and as part of advanced driver assist systems (ADAS). Focus tracking system 100 may identify the coordinates of surrounding objects, both stationery and mobile, by analyzing the distance vector to an object in three-dimensional space. It may provide rapid, real time, simultaneous and continuous point positioning of multiple stationary and mobile objects in the vehicle's vicinity, in relation to the vehicle's movement. It may additionally provide a spatial image of the vehicle's vicinity. Furthermore, it may provide the progress and path of mobile objects in the vicinity. Additionally, it may function in all lighting conditions, day and night.

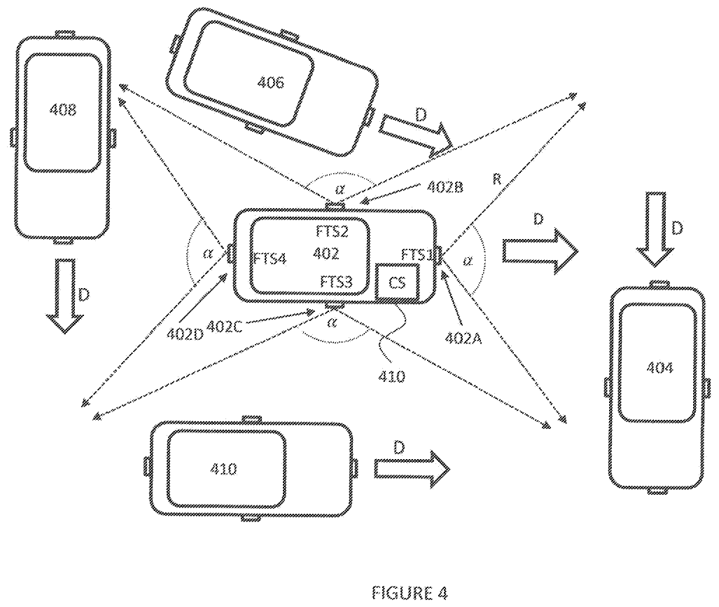

Reference is now made to FIG. 4 which schematically illustrates focus tracking system 100 installed in a vehicle 402, according to an embodiment of the present invention. In FIG. 4A, focus tracking system 100 is installed on vehicle A at locations 402A, 402B, 402C, and 402D, to provide 360° coverage of the vehicle, as shown by FTS1 on the front, FTS2 and FTS3 on the sides of the vehicle, and FTS4 on the rear of the vehicle. Although vehicle 402 is shown with FTS1, FTS2, FTS3, and FTS4, the skilled person may appreciate that the vehicle may include any number of FTS's to provide 360° coverage of the vehicle, which may be less than 4 FTSs or more than 4FTs, depending on the functional coverage of each FTS. Additionally, FTS1, FTS2, FTS3, and FTS4 may all be controlled by a single control system (CS) 410 which may be operatively similar to control system 113 shown in FIG. 3, obviating a need for each FTS to have its own control system. As may be appreciated from the figure, four vehicles 404, 406, 408, and 410 are moving in various directions, as depicted by the arrows D, around vehicle 402 with FTS1, FTS2, FTS3, and FTS4. FTS1 is focus tracking the movement of vehicle 404, FTS2 is focus tracking the movement of vehicle 406, FTS3 focus tracking the movement of vehicle 408, and FTS4 is focus tracking the movement of vehicle 410, as the vehicle moves in the directions designated by arrows D.

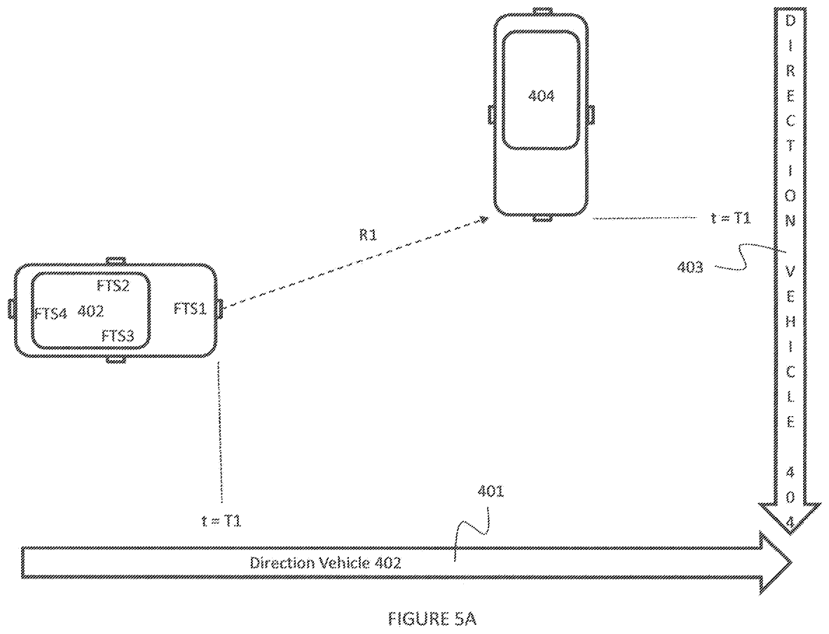

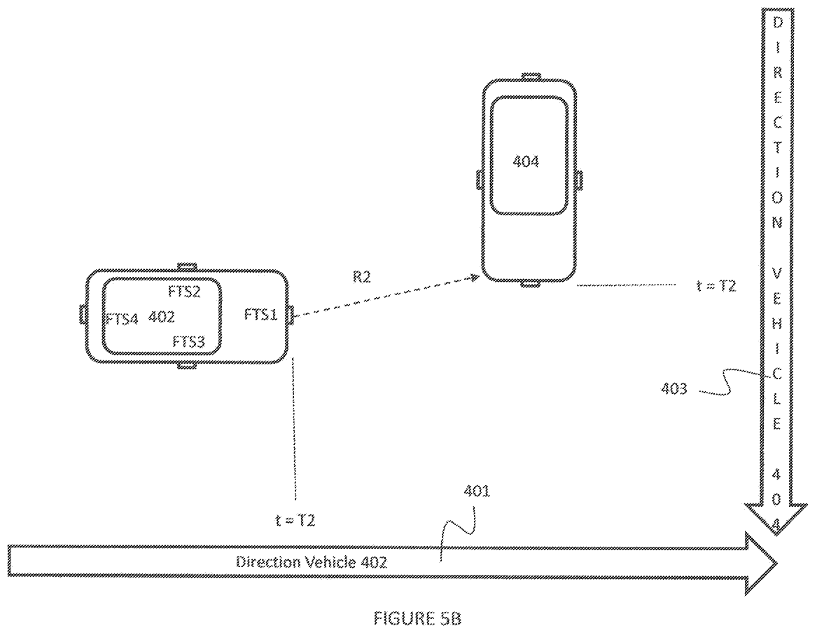

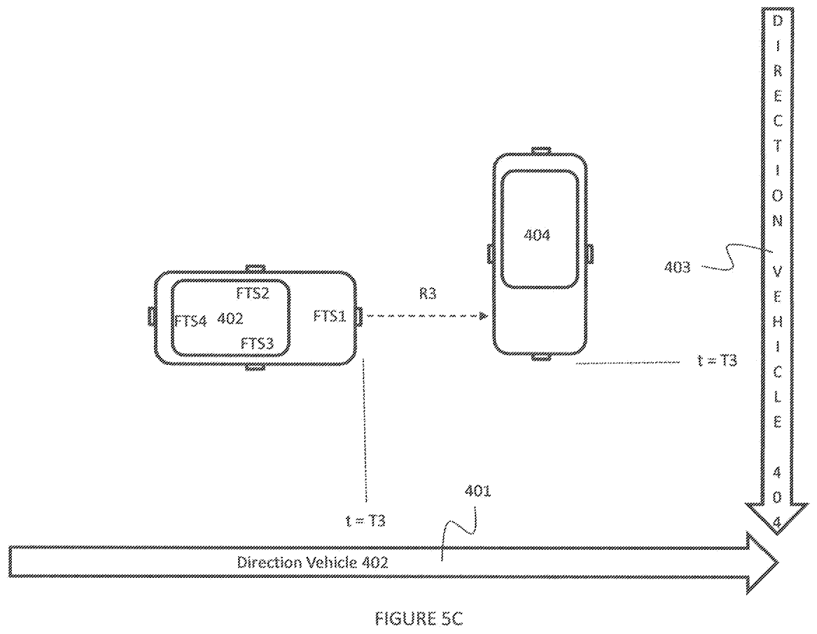

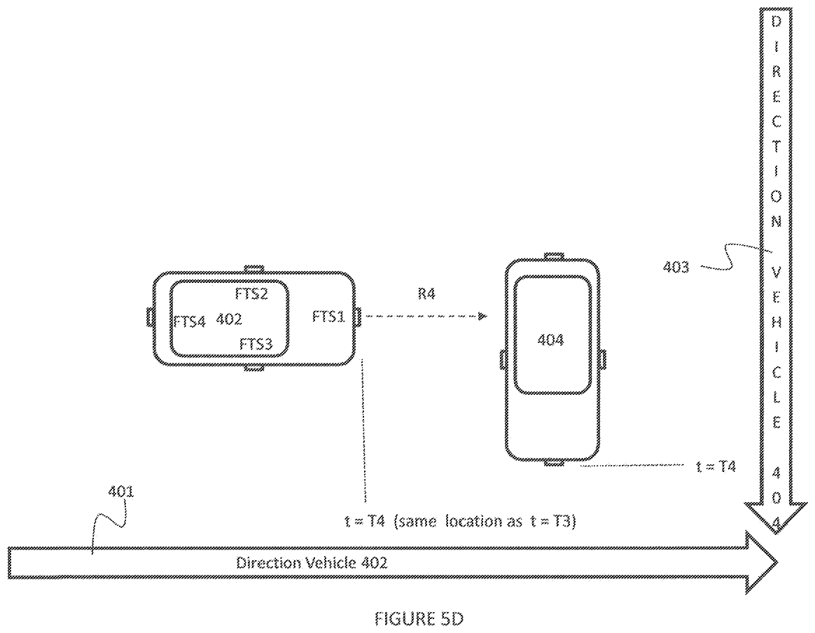

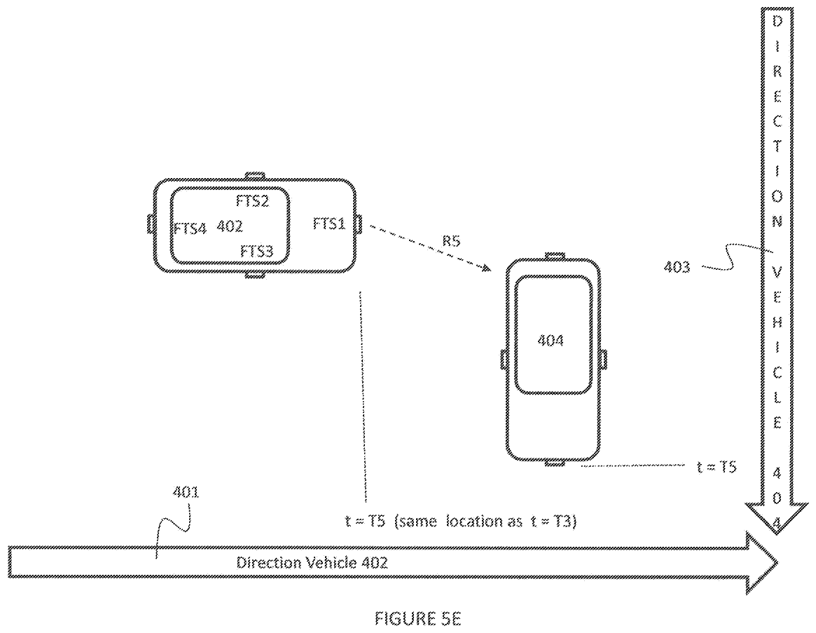

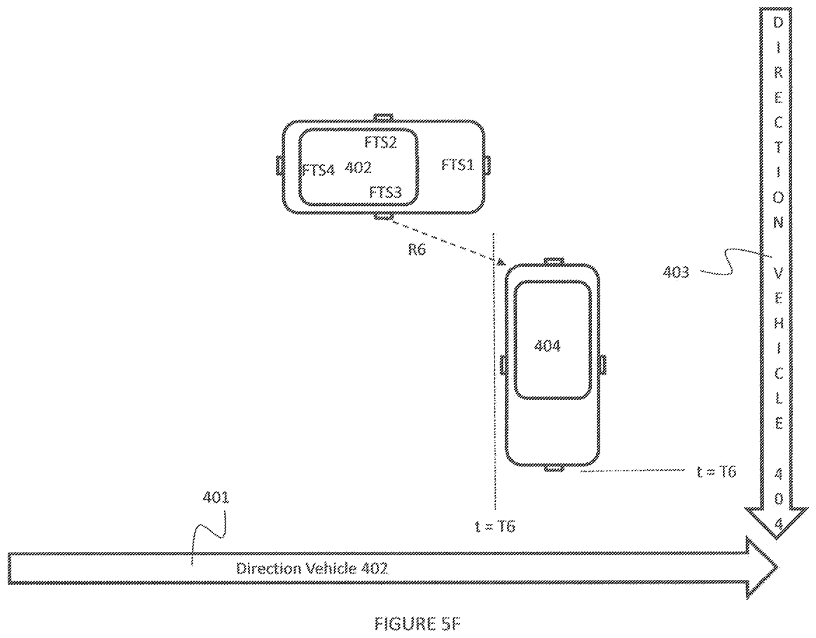

Reference is now made to FIGS. 5A to 5F which schematically illustrate an exemplary scenario of the use of FTS1, FTS2, FTS3, and FTS4 installed on vehicle 402 in FIG. 4, according to an embodiment of the present invention. In FIG. 5A, vehicle 402 is shown at a time t=T1 as it moves forward in the direction shown by arrow 401 (Direction Vehicle 402). Vehicle 404 is shown also at time t=T1 as it moves forward in the direction shown by arrow 403 (Direction vehicle 404) which traverses the path of vehicle 402. FTS1 on the front of vehicle 402 is tracking the position of vehicle 404, as shown by the rangefinder vector R1.

In FIG. 5B, vehicle 402 is shown at a time t=T2 as it continues to move forward in the direction shown by arrow 401. Vehicle 404 is shown also at time t=T2 as it also continues to move forward in the direction shown by arrow 403. FTS1 continues to track the position of vehicle 404, as shown by the rangefinder vector R2, which is continuing to approach vehicle 402.

In FIG. 5C, vehicle 402 is shown at a time t=T3 which has now come to a stop as vehicle 404 (also shown at time=T3) traverses the path of vehicle 402. FTS1, which is tracking the position of vehicle 404, as shown by the rangefinder vector R3, may be connected to an AV system which may automatically stop the vehicle, or to an ADAS which may instruct the driver to stop the vehicle.

In FIG. 5D, vehicle 402 is shown at time t=T4 which is still in the same position as at time t=T3 as vehicle 404 partially traverses the path of vehicle 402, also shown at time t=T4. FTS1 continues to track the position of the vehicle 404, as shown by rangefinder vector R4.

In FIG. 5E, vehicle 402 is shown at time t=T5 which is still in the same position as at time t=T3 as vehicle 404 almost completely traverses vehicle 402, also shown at time t=T5. FTS1 continues to track the position of vehicle 404, as shown by rangefinder vector R5, and signals the AV system or the ADAS that vehicle 404 is still obstructing.

In FIG. 5F, vehicle 402 is shown at a time t=T6 as it continues to move forward in the direction shown by arrow 401 since FTS1 no longer shows that vehicle 404 is an obstruction. Vehicle 404 is shown also at time t=T6 as it also continues to move forward in the direction shown by arrow 403 past vehicle 402. FTS3 now tracks the position of vehicle 404, as shown by the rangefinder vector R6, as it travels away from vehicle 402.

Exemplary Method of Using the Focus Tracking System

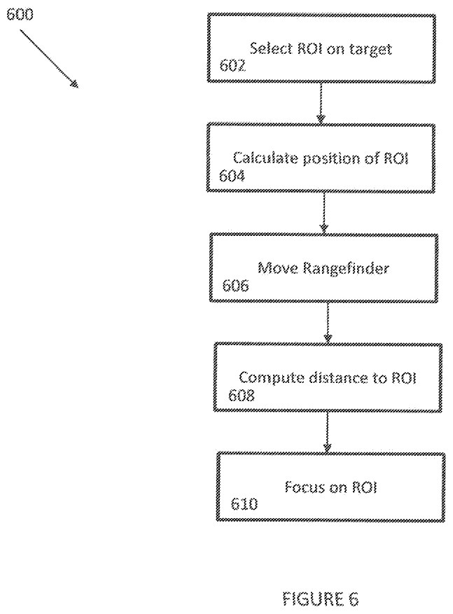

Reference is now made to FIG. 6 which is a flow chart of an exemplary method 600 of using the Focus Tracking System, according to an embodiment of the present invention. The method is not intended to be limiting in any form or manner and the skilled person may readily appreciate that the method may be implemented using more steps, less steps, and/or a different sequence of steps. For clarity, reference may be made to Focus Tracking System 100 shown in FIGS. 1 and 2, and its respective components shown in FIG. 3.

At 602, a ROI 122 may be selected by a system user on a target. The user may include a human, an intelligent system trained to select and identify the ROI, or may be otherwise selected on the target by electronic means. Imaging of ROI 122 may be done on sensor 104 of imaging system 102.

At 604, a change in position of ROI 122 (and the target) may be determined by computing a shift in the position of the image of the ROI inside X-Y plane 106 in sensor 104. The change in position may be associated with a change in the angle of view α. Calculation of the change in position of the target may be performed by control system 113 by determining the amount of the shift in the image of ROI 122 using computational methods which may include texture analysis of several consecutive images of the ROI on sensor 104, among other types of analysis. It may be appreciated that there may not be any change in position in the X-Y plane which corresponds with the target not having moved to the side, but the target may still be moving forward or backward changing focal plane. This forward or backward movement may only be detected at step 609. Alternatively, the target is not moving at all.

At 606, tracking system 109 may angularly displace rangefinder 107 to align the rangefinder with the position of ROI 122 (and the target) based on the calculated shift. Alternatively, rangefinder 107 is not angularly displaced as no shift is computed.

At 608, rangefinder 107 determines the distance to the target.

At 609, control system 113 processes the distance information from rangefinder 107 and may send control signaling to auto focus system 105 to adjust camera 103 lens to focus onto the target. It may be appreciated that, if there is no change in the angle of view α, it may not be necessary to perform the focusing and it may be enough to determine the distance to the target.

Unless specifically stated otherwise, as apparent from the preceding discussions, it is appreciated that, throughout the specification, discussions utilizing terms such as “processing,” “computing,” “calculating,” “determining,” or the like, refer to the action and/or processes of a general purpose computer of any type such as a client/server system, mobile computing devices, smart appliances or similar electronic computing device that manipulates and/or transforms data represented as physical, such as electronic, quantities within the computing system's registers and/or memories into other data similarly represented as physical quantities within the computing system's memories, registers or other such information storage, transmission or display devices.

Embodiments of the present invention may include apparatus for performing the operations herein. This apparatus may be specially constructed for the desired purposes, or it may comprise a general-purpose computer selectively activated or reconfigured by a computer program stored in the computer. The resultant apparatus when instructed by software may turn the general purpose computer into inventive elements as discussed herein. The instructions may define the inventive device in operation with the computer platform for which it is desired. Such a computer program may be stored in a computer readable storage medium, such as, but not limited to, any type of disk, including optical disks, magnetic-optical disks, read-only memories (ROMs), volatile and non-volatile memories, random access memories (RAMs), electrically programmable read-only memories (EPROMs), electrically erasable and programmable read only memories (EEPROMs), magnetic or optical cards, Flash memory, disk-on-key or any other type of media suitable for storing electronic instructions and capable of being coupled to a computer system bus.

The processes and displays presented herein are not inherently related to any particular computer or other apparatus. Various general-purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A method of automatically tracking a moving target comprising:
viewing on an imager a region of interest (ROI) on the target;
acquiring a first image of said ROI and mapping a set of points associated with said first ROI image on an X-Y coordinate system associated with a focal plane in a field of view (FOV) of said imager;
acquiring a second image of said ROI and mapping a set of points associated with said second ROI image on said X-Y coordinate system;
comparing a location of said first set of ROI image points on said X-Y coordinate system with said second set of ROI image points;
computing a first angular distance between said first set of ROI points and said second set of ROI points; and
determining whether said ROI has moved to a different focal plane.

2. A method according to claim 1 further comprising using texture analysis to map said first set of ROI points and said second set of ROI points.

3. A method according to claim 1 further comprising using texture analysis to compute said first angular distance.

4. A method according to claim 1 wherein said first set of points and said second set of points each comprise at least one or more coordinates on said X-Y coordinate system.

5. A method according to claim 1 further comprising using said first angular distance to compute a first angle of deviation between said ROI and a line extending perpendicularly from said imager to said focal plane.

6. A method according to claim 5 comprising measuring a distance to said ROI along a vector extending from said imager at said first angle of deviation.

7. A method according to claim 1 further comprising acquiring a third image of said ROI and mapping a set of points associated with said third ROI image on said X-Y coordinate system.

8. A method according to claim 7 comprising comparing a location of said third set of ROI image points on said X-Y coordinate system with said second set of ROI image points.

9. A method according to claim 8 comprising computing a second angular distance between said third set of ROI points and said second set of ROI points.

10. A method according to claim 9 comprising using said second angular distance to compute a second angle of deviation between said ROI and said line extending perpendicularly from said imager to said focal plane.

11. A method according to claim 10 comprising measuring a distance to said ROI along a vector extending from said imager at said second angle of deviation.

12. A method according to claim 1 further comprising acquiring said first ROI image and said second ROI image using a frame speed greater than 25 frames per second.

13. A method according to claim 1 further comprising acquiring said first ROI image and said second ROI image using a frame speed of 100 frames per second.

14. A method according to claim 1 wherein said focal plane is associated with a focal distance from said imager.

15. A method according to claim 1 further comprising automatically adjusting a focus based on said determining whether said ROI has moved to a different focal plane.

16. A system for automatically tracking a moving target comprising:
an imager for viewing a region of interest (ROI) on the target;
a sensor for acquiring a first image of said ROI and for acquiring a second image of said ROI; and
a control system for:
mapping a set of points associated with said first ROI image on an X-Y coordinate system associated with a focal plane in a field of view (FOV) of said imager and for mapping a set of points associated with said second ROI image on said X-Y coordinate system;
comparing a location of said first set of ROI image points on said X-Y coordinate system with said second set of ROI image points;
computing a first angular distance between said first set of ROI points and said second set of ROI points; and
determining whether said ROI has moved to a different focal plane.

17. A system according to claim 16 further comprising said control system using texture analysis to map said first set of ROI points and said second set of ROI points.

18. A system according to claim 16 further comprising said control system using texture analysis to compute said first angular distance.

19. A system according to claim 16 wherein said first set of points and said second set of points each comprise at least one or more coordinates on said X-Y coordinate system.

20. A system according to claim 16 further comprising said control system using said first angular distance to compute a first angle of deviation between said ROI and a line extending perpendicularly from said imager to said focal plane.

21. A system according to claim 20 further comprising a rangefinder to measure a distance to said ROI along a vector extending from said imager at said first angle of deviation.

22. A system according to claim 16 further comprising said sensor acquiring a third image of said ROI and mapping a set of points associated with said third ROI image on said X-Y coordinate system.

23. A system according to claim 22 comprising said control system comparing a location of said third set of ROI image points on said X-Y coordinate system with said second set of ROI image points.

24. A system according to claim 23 comprising said control system computing a second angular distance between said third set of ROI points and said second set of ROI points.

25. A system according to claim 23 comprising said control system using said second angular distance to compute a second angle of deviation between said ROI and said line extending perpendicularly from said imager to said focal plane.

26. A system according to claim 22 comprising a rangefinder measuring a distance to said ROI along a vector extending from said imager at said second angle of deviation.

27. A system according to claim 16 comprising said imager acquiring said first ROI image and said second ROI image using a frame speed greater than 25 frames per second.

28. A system according to claim 16 comprising said imager acquiring said first ROI image and said second ROI image using a frame speed of 100 frames per second.

29. A system according to claim 16 wherein said focal plane is associated with a focal distance from said imager.

30. A system according to claim 16 further comprising an automatic focus system to automatically adjust a focus of said imager based on whether said ROI has moved to a different focal plane.
